(19) United States
(12) Patent Application Publication
(10) Pub. No.: US 2006/0165377 A1
(43) Pub. Date: Jul. 27, 2006

(54) Method for reproducing video clips

(76) Inventor: Thomas von Wendt, Breitscheid-Erbach (DE)

Correspondence Address: IP STRATEGIES, 12 1/2 WALL STREET, SUITE I, ASHEVILLE, NC, 28801, US

(21) Appl. No.: 11/043,344

(22) Filed: Jan. 26, 2005

(51) Int. Cl. H04N 5/91

(52) U.S. Cl. 386/94

(57) ABSTRACT

This invention provides a method of reproducing at least one video clip on a computer screen and at least one music piece out of a plurality of video clips and music pieces stored on a data carrier, each of the video clips being linked with one of the music pieces, wherein the following steps are provided: selecting at least one of the plurality of video clips and at least one of the plurality of music pieces for reproduction; displaying simultaneously the at least one selected video clip in the selected segments with the respective selected magnification factor, and reproducing one of the selected music pieces, whereby the selected segments with the at least one selected video clip are overlaid to each other on the screen according to a predefined scheme, the predefined scheme defining which one of the segments is displayed where at least two of the selected segments are overlapping on the screen, and defining the one music piece of the selected music pieces linked with the selected video clips which is to be reproduced.

### BACKGROUND OF THE INVENTION

This application relates to a method for reproducing video clips stored on a data carrier, whereby the data carrier comprises a plurality of video clips and a plurality of music pieces, as well as to a data carrier comprising a program which implements the inventive method.

### STATE OF THE ART

Methods for reproducing music pieces stored on a data carrier are well known.

Also well known are methods for reproducing music together with moving images stored on data carriers, like videos on DVDs etc. However, especially with respect to music video clips, reproducing one and the same video clips several times in exactly the same way becomes annoying. Of course, there exists a method which allows to play a random sequence of a number of video clips stored on a data carrier. However, keeping in mind that a commercially available CDROM or DVD carrier has a limited capacity as well as for the sake of user friendliness, the variability of different selections are limited.

Therefore, especially for music video clips, it would be desirable to have a facility for composing, from a data carrier, video clips together with music pieces and to bring them into a sequence which provides some ease to observe.

### SUMMARY OF THE INVENTION

In general, in one aspect, this invention provides a computer-implemented method of reproducing at least one video clip on a computer screen and at least one music piece out of a plurality of video clips and music pieces stored on a data carrier, each of the video clips being linked with one of the music pieces, wherein the following steps are provided:
selecting at least one of the plurality of video clips and at least one of the plurality of music pieces for reproduction;
selecting a number of segments on the screen for displaying the at least one selected video clip therein, each of the screen segments having
   a predefined position on the screen;
   a size which is selectable out of a set of different predefined sizes;
   a magnification factor for a video clip to be displayed in the screen segment;
selecting a video clip magnification factor out of a number of predefined factors for each of the selected screen segments;
displaying simultaneously the at least one selected video clip in the selected segments with the respective selected magnification factor, and reproducing one of the selected music pieces, whereby the selected segments with the at least one selected video clip are overlaid to each other on the screen according to a predefined scheme, the predefined scheme defining which one of the segments is displayed where at least two of the selected segments are overlapping on the screen, and defining the one music piece of the selected music pieces linked with the selected video clips which is to be reproduced.

In a further aspect, this invention provides a computer-implemented method of reproducing at least one video clip on a computer screen out of a plurality of video clips stored on a data carrier, wherein the following steps are provided:
selecting at least one of the plurality of video clips for reproduction;
selecting a number of segments on the screen for displaying the at least one selected video clip therein, each of the screen segments having
   a predefined position on the screen;
   a size which is selectable out of a set of different predefined sizes;
   a magnification factor for a video clip to be displayed in the segment;
selecting a video clip magnification factor out of a number of predefined factors for each of the selected screen segments;
displaying simultaneously the at least one selected video clip in the selected segments with the respective selected magnification factor, whereby the selected segments with the at least one selected video clip are overlaid to each other on the screen according to a predefined scheme, the predefined scheme defining which one of the segments is displayed where at least two of the selected segments are overlapping on the screen.

In yet a further aspect, this invention comprises a computer-readable storage medium comprising a plurality of video clips and a plurality of music pieces, and program code for controlling, when loaded into a computer system, the computer system such as to allow the following steps to be performed:
selecting at least one of the plurality of video clips and at least one of the plurality of music pieces for reproduction;
selecting a number of segments on the screen for displaying the at least one selected video clip therein, each of the screen segments having
   a predefined position on the screen;
   a size which is selectable out of a set of different predefined sizes;
   a magnification factor for a video clip to be displayed in the screen segment;
selecting a video clip magnification factor out of a number of predefined factors for each of the selected screen segments;
displaying simultaneously the at least one selected video clip in the selected segments with the respective selected magnification factor, and reproducing one of the selected music pieces, whereby the selected segments with the at least one selected video clip are overlaid to each other on the screen according to a predefined scheme, the predefined scheme defining which one of the segments is displayed where at least two of the selected segments are overlapping on the screen, and defining the one music piece of the selected music pieces linked with the selected video clips which is to be reproduced.

Yet further provided is a bundle of storage media, comprising:
at least one computer-readable storage medium according to claim 14, and
at least one audio storage medium, the audio storage medium being capable of being reproduced in an audio disk player, and comprising music pieces recorded thereon which correspond to the music pieces stored on the computer-readable storage medium.

The overlay scheme may comprise: Overlaying the one of the selected video clips having the smallest magnification factor over the other selected video clips, and displaying it in the innermost segment of the selected segments of the screen.

The number of the selected video clips may be four, and the set of predefined magnification factors may comprise 100%, 75%, 50%, 25% of the display screen size.

The image segments may be rectangular and respective corners of the image segments may be on straight lines, whereby the straight lines may meet in the center of the screen.

In a further embodiment of the invention at least one of the following steps are provided:
adding visual components;
clearing visual components;
exchanging visual components.

The clips each may comprise 360° panoramic views of a scene.

In a yet further embodiment of the invention, a smaller video clip appears on top of a larger video clip.

The number of screen segments to be selected may be preset.

Yet further, all the panoramic views may virtually move with the same angular velocity.

In a further embodiment of the invention, the selected video clips are overlaid such that the innermost is the smallest screen segment and is superposed to the other screen segments being displayed.

In all embodiments of the invention a control panel may be provided on the screen in which buttons for selecting the clips are displayed.

The invention may further comprise: providing a set of sizes for the segments such that the visual impression of a funnel is generated.

The video clips may be reproduced in different sizes and freely combined with each other.

In particular, the invention comprises also computer systems for performing the inventive methods.

Furthermore, the invention comprises computer-readable storage media comprising program code for performing the inventive methods, when loaded into a computer system.

Thus, the present invention provides a method of reproducing video clips and music pieces stored on a data carrier, whereby the video clips may be displayed on a screen, whereby each of the video clips are displayed in different sizes simultaneously, centered on the screen which provides particularly impressive perspectives and can be freely combined with each other.

### BRIEF DESCRIPTION OF DRAWINGS

The invention will be better understood on the basis of the detailed description in connection with the drawings, wherein

FIG. 1 illustrates a flow diagram of the inventive method;

FIG. 2 illustrates the first screen of the computer program of the invention;

FIG. 3 illustrates several menus of the control panel;

FIG. 4a, 4b illustrate still images of the 13 stored clips in Basic Mode, and of the 13 stored combinations of clips in Preset Mode, respectively;

FIG. 5 illustrates clips of the Preset Mode of the present invention;

FIG. 6 illustrates a clip of the Basic Mode of the present invention;

FIG. 7 illustrates a chat window in the screen; and

FIG. 8 illustrates a clip of the Basic Mode in another segmentation of the screen;

FIG. 9 illustrates the image directory;

FIG. 10 illustrates the window upon “xt” selection;

FIG. 11 illustrates an example of the resulting screen; and

FIG. 12 illustrates a flow diagram of a further embodiment of the invention.

### DETAILED DESCRIPTION

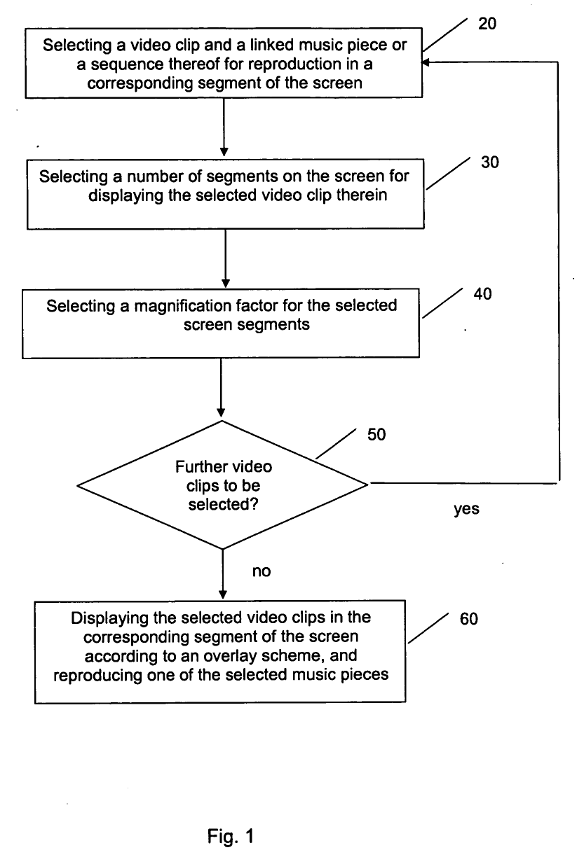

FIG. 1 gives a flow diagram of a computer program which implements the inventive method. The program is to be run on a computer which comprises a display screen connected thereto, as well as a storage drive such as a CD ROM drive or a DVD drive. On the screen, the video clips as well as a control panel can be displayed.

The program controls the computer such that it forms a combined audio/video player. In step 20, the user is enabled to select a video clip and a music piece (i.e., an audible song), or a sequence thereof, for reproduction. In step 30, the segment of the screen of the computer is selected wherein the selected video clip is to be displayed. Furthermore, the magnification factor is to be selected by the user—step 40. If the user wants to select a further video clip and music piece linked—step 50—the program loops back to step 20 and enables the user to select a further video clip and music piece. If not, the program proceeds to step 60 wherein the clips are displayed each in the corresponding segment of the screen of the computer, together with one of the selected music pieces, according to an overlay scheme which is described below.

In the following, a particular embodiment of the invention is described. This embodiment runs on any personal computer in connection with commercially available media player software. The media player provides the basic functionality of displaying a video clip and reproducing music pieces.

The data carrier in this embodiment (a CD or a DVD) comprises 13 different video clips and 13 different music pieces (audible songs). Furthermore, the data carrier comprises the program code for controlling the media player. As an alternative, the program code may be stored separately and independently from the video clips and from the music pieces on another data carrier or directly on the computer.

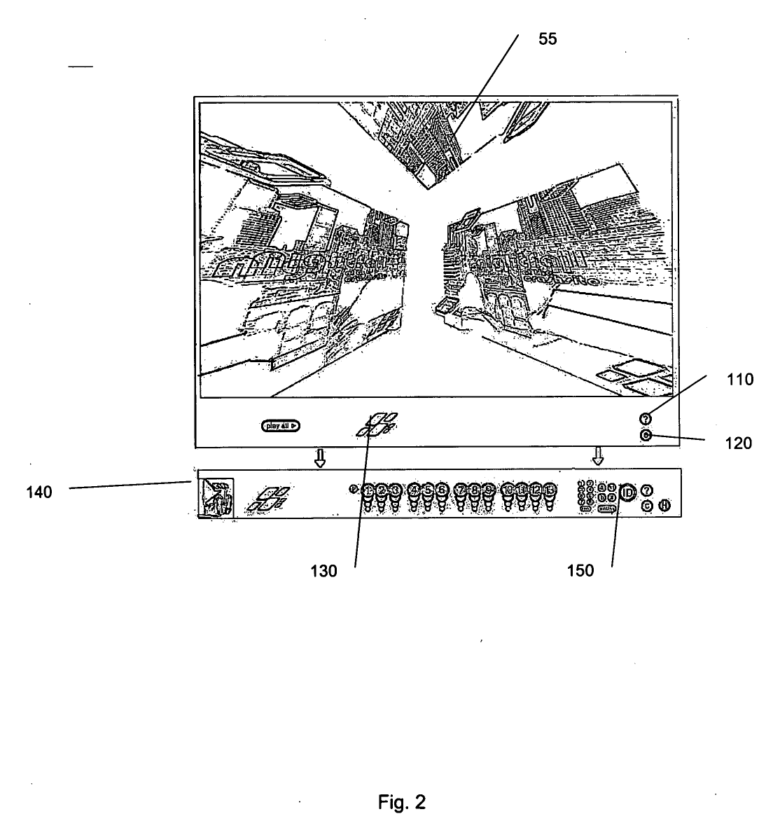

FIG. 2 shows the computer program upon start up. Screen 55 is the first screen of the program.

Virtually all functions of the program are started by mouse clicking on the “soft buttons” on the screen.

By clicking on the logo area 130, a control panel 140 is displayed which allows for controlling the functions of the player.

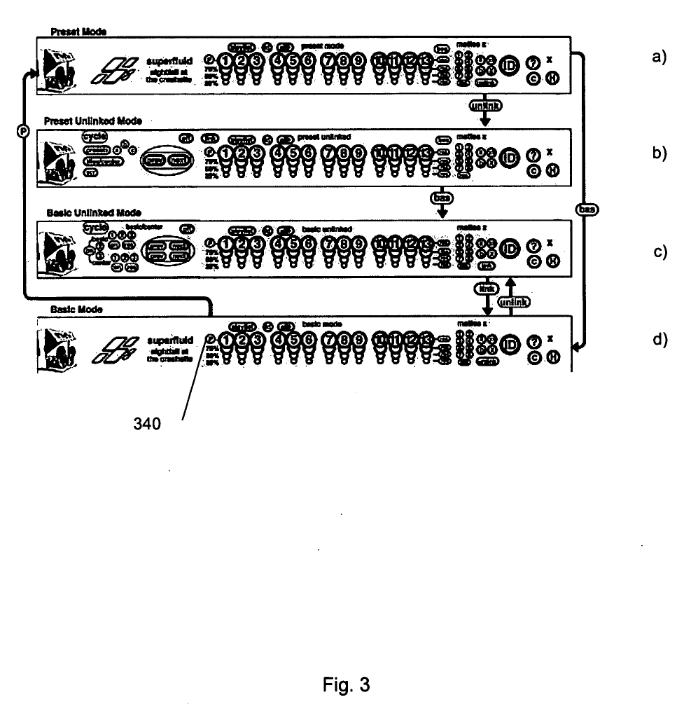

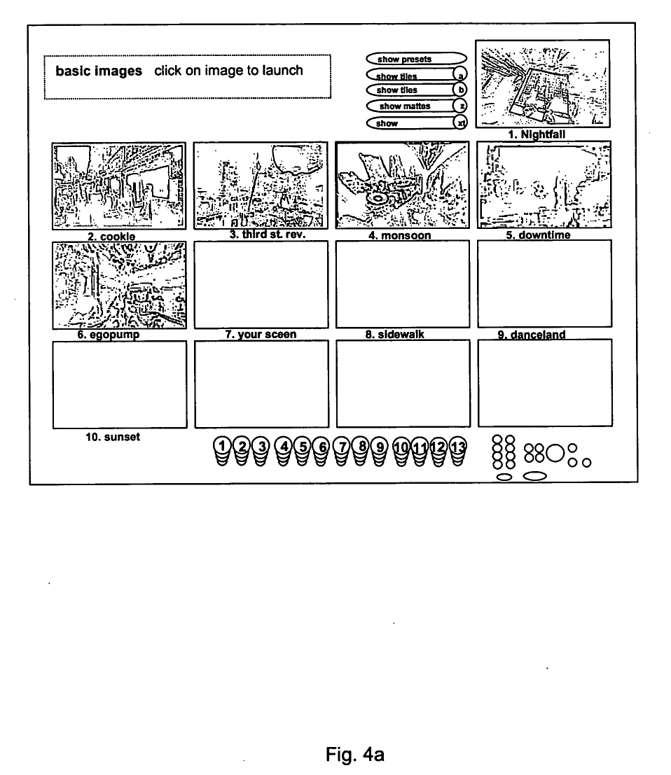

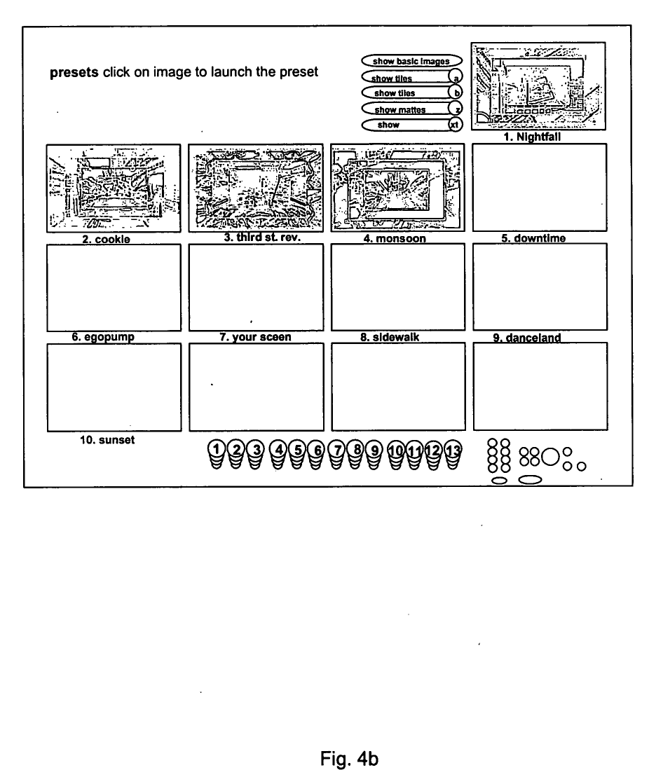

FIGS. 3a-d show the control panel 140 for several menus. By clicking on “bas” button in FIG. 3a, the “Basic Mode” is opened, and the control panel according to FIG. 3d is displayed. In the Basic Mode, the video clips stored on the data carrier can be reproduced individually. In this embodiment, there are 13 different video clips. FIG. 4a shows still images out of these 13 video clips. Each of the 13 video clips can be selected to be started by clicking on the buttons labeled with 1 to 13 in FIG. 3d. In the Basic Mode, each video clip is linked with one of the music pieces stored on the data carrier.

The 13 video clips are the basis for all combinations of clips generated by the player. The progressively smaller buttons in each column are for displaying the respective video clip in a smaller size (75%, 50%, 25% of the full size, respectively). Any of these clips may be combined with each other. The combinations of clips are only limited by the number of available screen segments.

By clicking the P button 340 (FIG. 3d) of the control panel, the “Preset Mode” is started. In the “Preset Mode”, one of several preset combination clips can be selected for being reproduced. FIG. 4b shows the 13 combination clips contained in the “Preset Mode”. Each of these preset combination clips comprises four different video clips (as displayable in the Basic Mode). The preset combination clips can be started to be reproduced by clicking on the buttons numbered 1 to 13 on the control panel. Each preset combination visual is reproduced together with the linked music piece (song). A further control button is provided (“Play All”) which allows for playing the 13 preset combination clips sequentially.

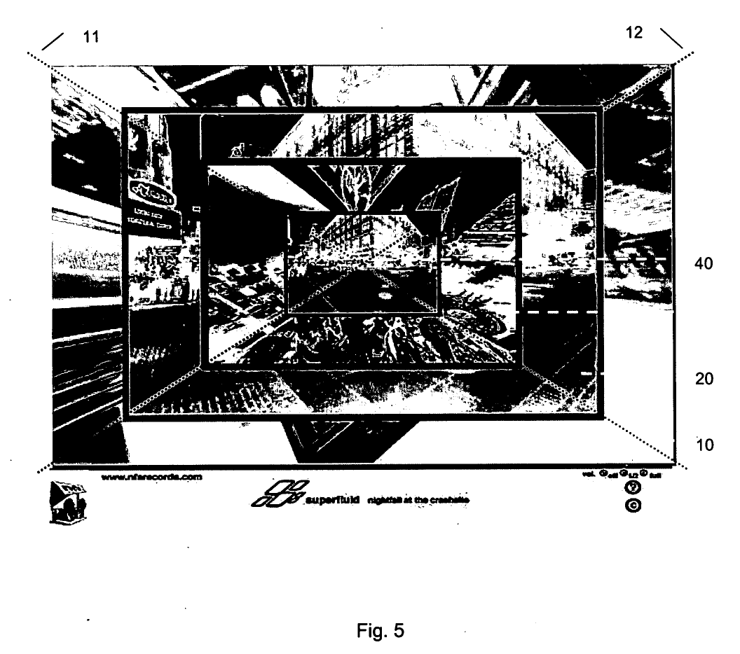

The screen wherein the four video clips are simultaneously displayed in this embodiment is segmented as shown in FIG. 5. According to FIG. 5, the four video clips are displayed, each clip in a respective segment 10, 20, 30, 40 of the screen. The segments are rectangular. Where the segments are overlapping, an overlay scheme is applied. The innermost segment 40 appears to be superposed over the other three segments 10, 20, 30. The segment 30 is behind the innermost segment 40. From the outermost segment 10, only border bands are visible. As can be seen in FIG. 5, the clips which are displayed in the respective segments are magnified in different sizes. The magnification factors of the clip from the innermost segment 40 to the outermost segment 10 are 25:50:75:100.

Since the respective corners of the image segments are on straight lines 11, and 12 which intersect in the center of the screen, the visual impression of a funnel is produced.

As to the music pieces linked with the clips, only the one which is linked with the video clip in the innermost segment is reproduced.

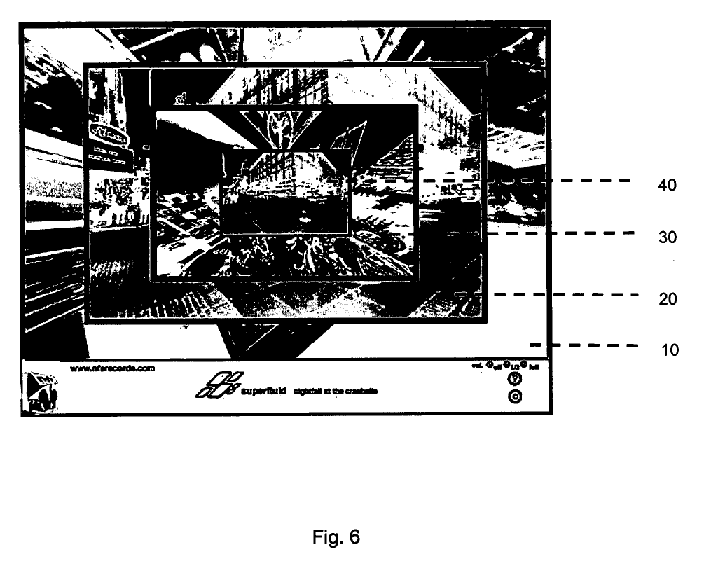

In the Basic Mode, where only one video clip is reproduced at a time, this clip can be displayed simultaneously in all the four segments, whereby the clip is magnified in each segment with the magnification factor associated with that respective segment, see FIG. 6.

Additionally to the preset combinations of video clips, a user may generate his own combinations of video clips by selecting some of the stored video clips for reproduction as already described in connection with the previous Figures. As can be seen from FIG. 3b, the user may select the stored video clip as well as the magnification factor thereof, i.e., 25%, 50%, 75%, or 100%, by mouse clicking on the respective button 1 to 13. Depending upon the magnification factor selection, the segment in which the clip is to be displayed is selected for display. Thus, an arbitrarily large number of individual combinations of video clips can be created. For doing that, the menus starting from “unlinked” according to FIGS. 3b and 3c are provided.

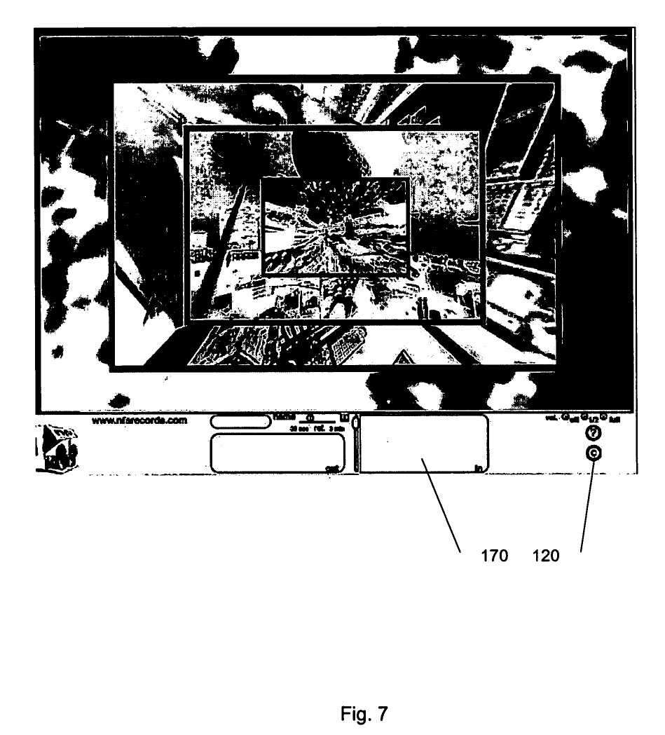

By clicking on the ? (question mark) button 110 (in FIG. 2) on the screen, an online operation manual is opened. By clicking on the C button 120, a window 170 (FIG. 7) is opened which allows writing and reading textual messages for transmission to a virtual “chat room”, see FIG. 7. The virtual chat room may be accessed via internet and may be used by other users of the player. This window can be opened in any stage of the program.

Further functionalities are provided. The user may play all the clips with linked music pieces sequentially by clicking on the button “all”. Furthermore, a control panel is provided where the 13 clips can be selected by clicking on the title associated with each clip.

It has been found that the number four and the values of magnification factors 25%, 50%, 75%, and 100% are a particularly good selection.

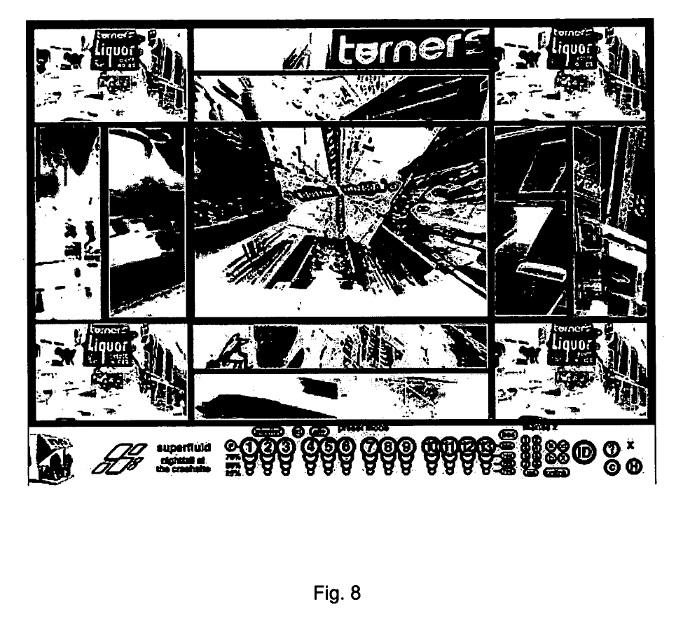

FIG. 8 shows, as a further example, another segmentation of the screen according to the invention, again in Basic Mode.

It is to be understood that other magnification factors or overlay schemes for the segments or other numbers of clips to be displayed may be applied without departing from the spirit of the invention. In the same way, the number 13 of stored clips and music pieces are not limitative for the invention.

Furthermore, a large-size display panel may be used for displaying the video clips. Then, the invention may be applied in the frame of big events.

Yet further, the CD ROM drive or DVD drive may be separated from the computer where the player software is run. In that case, the video clips and/or music pieces are downloaded on the computer via a communication network, such as the internet.

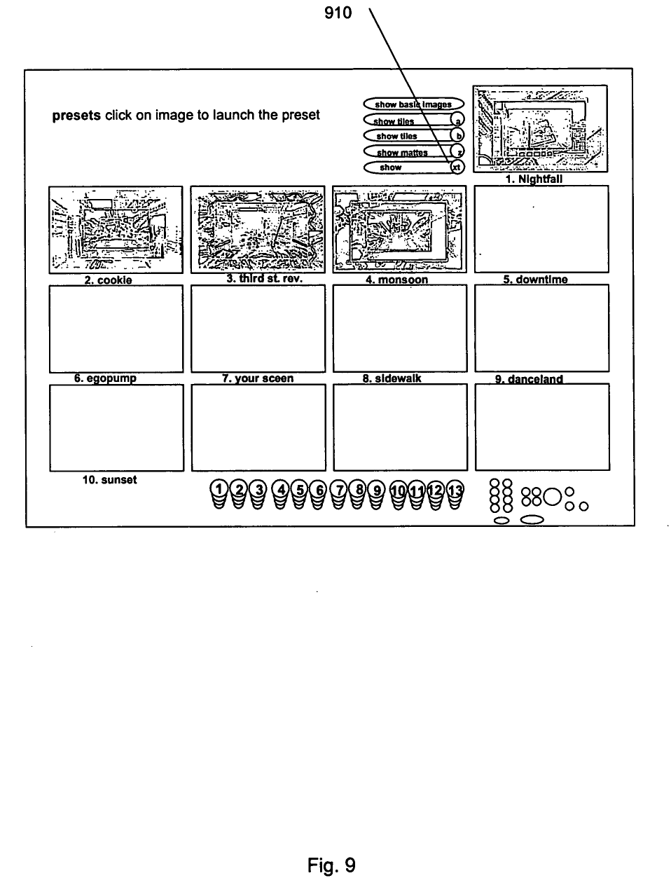

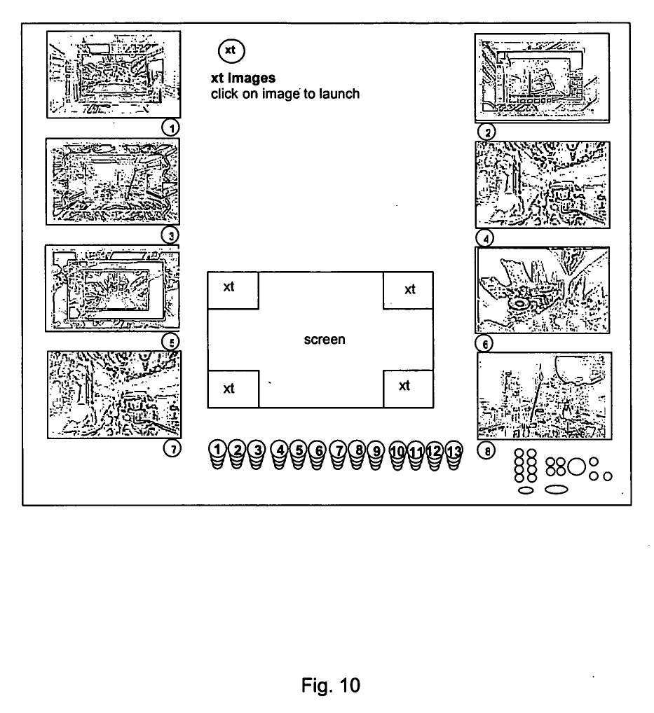

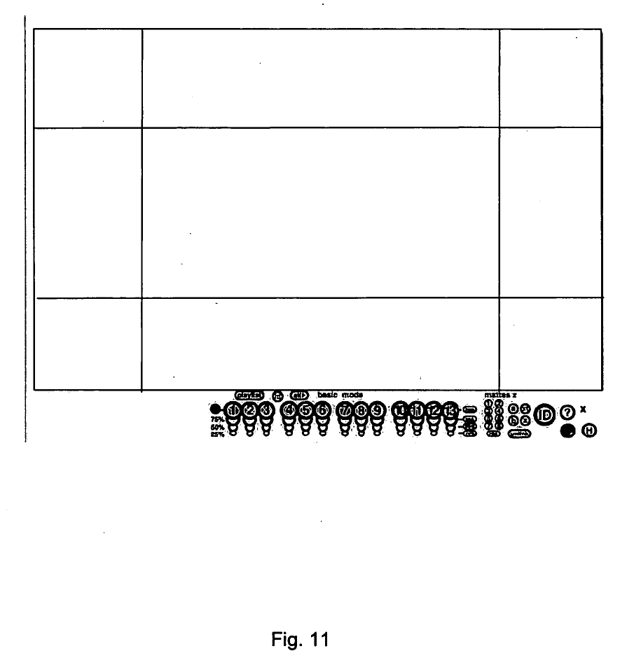

A further feature of the invention is the provision of an image directory. By clicking on the “ID” button 150 button (refer again to FIG. 2), the image directory is displayed in a window on the screen. FIG. 9 shows the image directory screen. The image directory displays one still image of each basic clip. By clicking on one of the still images, the corresponding clip in basic Mode is reproduced on the screen. Starting from the image directory (ID) window, further windows can be opened. By clicking on “show xt” button 910, the window of FIG. 10 is opened wherein one of the basic clips can be selected to be displayed in the four corners labeled “xt”, as displayed in the scheme in the center of that window. The clip can be superposed to one or more clips which are already displayed on the screen. FIG. 11 shows an example of the resulting screen.

In a further embodiment of the invention, the data carrier according to the invention containing the video clips as well as the music pieces and the media player control program is provided bundled with an ordinary audio CD or DVD containing only the music pieces. The user may then have the choice of playing the songs either from the audio carrier on an ordinary CD/DVD player or from the data carrier together with the video clips on a personal computer.

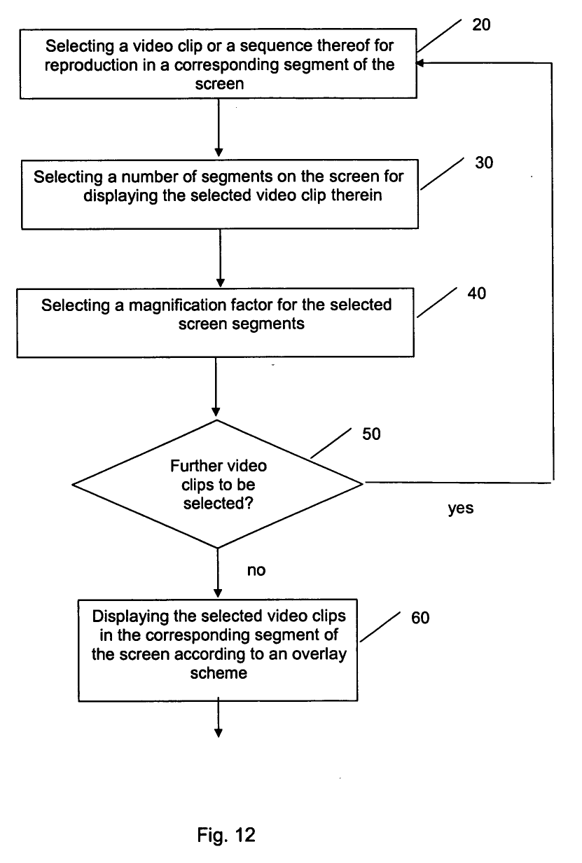

In yet a further embodiment of the invention, the sound components are omitted. In this embodiment, only the visual components are reproduced but without music piece. Therefore, step 20 of the method according to FIG. 1 is modified in such that only a video clip is selected for reproduction but no music piece. Step 60 is reduced to displaying the video clips. FIG. 12 illustrates the method steps according to this embodiment. Since the other steps are the same as in FIG. 1, their description is not repeated at this point. This embodiment is particularly useful in the context of advertising.

The present techniques can also be implemented in digital electronic circuitry, or in computer hardware, firmware, software, or in combinations of them. Apparatus of the invention can be implemented in a computer program product tangibly embodied in a machine-readable storage device for execution by a programmable processor. Method steps according to the invention can be performed by a programmable processor executing a program of instructions to perform functions of the invention by operating on the basis of input data, and by generating output data. The invention may be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, and/or in assembly or machine code. The language or code can be a compiled or interpreted language or code. Processors may include general and special purpose microprocessors. A processor receives instructions and data from memories, in particular from read-only memories and/or random access memories. A computer may include one or more mass storage devices for storing data; such devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks or DVDs. Any of the foregoing can be supplemented by or incorporated in ASICs (application-specific integrated circuits).

The computer systems or distributed computer networks as mentioned above may be used, for example, for producing goods, delivering parts for assembling products, controlling technical or economical processes, or implementing telecommunication activities.

A computer may include a processor, memory coupled to the processor, a hard drive controller, a video controller and an input/output controller coupled to the processor by a processor bus. The hard drive controller is coupled to a hard disk drive suitable for storing executable computer programs, including programs embodying the present technique. The I/O controller is coupled by means of an I/O bus to an I/O interface. The I/O interface receives and transmits in analogue or digital form over at least one communication link. Such a communication link may be a serial link, a parallel link, local area network, or wireless link (e.g. an RF communication link). A display is coupled to an interface, which is coupled to an I/O bus. A keyboard and pointing device are also coupled to the I/O bus. Alternatively, separate buses may be used for the keyboard pointing device and I/O interface.

1. A computer-implemented method of reproducing at least one video clip on a computer screen and at least one music piece out of a plurality of video clips and music pieces stored on a data carrier, each of the video clips being linked with one of the music pieces,
wherein the following steps are provided:
selecting at least one of the plurality of video clips and at least one of the plurality of music pieces for reproduction;
selecting a number of segments on the screen for displaying the at least one selected video clip therein, each of the screen segments having
a predefined position on the screen;
a size which is selectable out of a set of different predefined sizes;
a magnification factor for a video clip to be displayed in the screen segment;
selecting a video clip magnification factor out of a number of predefined factors for each of the selected screen segments;
displaying simultaneously the at least one selected video clip in the selected segments with the respective selected magnification factor, and reproducing one of the selected music pieces, whereby
the selected segments with the at least one selected video clip are overlaid to each other on the screen according to a predefined scheme, the predefined scheme defining which one of the segments is displayed where at least two of the selected segments are overlapping on the screen, and defining the one music piece of the selected music pieces linked with the selected video clips which is to be reproduced.

2. The method of claim 1, wherein the scheme comprises:
Overlaying the one of the selected video clips having the smallest magnification factor over the other selected video clips, and displaying it in the innermost segment of the selected segments of the screen.

3. The method of claim 2, wherein the number of the selected video clips is four, and the set of predefined magnification factors comprises 100%, 75 %, 50%, 25% of the display screen size.

4. The method of claim 3, wherein the image segments are rectangular and respective corners of the image segments are on straight lines, whereby the straight lines meet in the center of the screen.

5. The method of claim 1, further providing at least one of the following steps:
adding visual components;
clearing visual components;
exchanging visual components.

6. The method of claim 1, wherein the clips each comprise 360° panoramic views of a scene.

7. The method of claim 1, wherein a smaller video clip appears on top of a larger video clip.

8. The method of claim 1, wherein the number of screen segments to be selected is preset.

9. The method of claim 6, wherein all the panoramic views virtually move with the same angular velocity.

10. The method of claim 1, wherein the selected video clips are overlaid such that the innermost is the smallest screen segment and is superposed to the other screen segments being displayed.

11. The method of claim 1, wherein a control panel is provided on the screen in which buttons for selecting the clips are displayed.

12. The method of claim 1, providing a set of sizes for the segments such that the visual impression of a funnel is generated.

13. The method of claim 1, wherein the video clips are reproduced in different sizes and freely combined with each other.

14. A computer-implemented method of reproducing at least one video clip on a computer screen out of a plurality of video clips stored on a data carrier,
wherein the following steps are provided:
selecting at least one of the plurality of video clips for reproduction;
selecting a number of segments on the screen for displaying the at least one selected video clip therein, each of the screen segments having
a predefined position on the screen;
a size which is selectable out of a set of different predefined sizes;
a magnification factor for a video clip to be displayed in the segment;
selecting a video clip magnification factor out of a number of predefined factors for each of the selected screen segments;
displaying simultaneously the at least one selected video clip in the selected segments with the respective selected magnification factor, whereby
the selected segments with the at least one selected video clip are overlaid to each other on the screen according to a predefined scheme, the predefined scheme defining which one of the segments is displayed where at least two of the selected segments are overlapping on the screen.

15. A computer-readable storage medium comprising a plurality of video clips and a plurality of music pieces, and program code for controlling, when loaded into a computer system, the computer system such as to allow the following steps to be performed:
selecting at least one of the plurality of video clips and at least one of the plurality of music pieces for reproduction;
selecting a number of segments on the screen for displaying the at least one selected video clip therein, each of the screen segments having
a predefined position on the screen;
a size which is selectable out of a set of different predefined sizes;
a magnification factor for a video clip to be displayed in the screen segment;
selecting a video clip magnification factor out of a number of predefined factors for each of the selected screen segments;
displaying simultaneously the at least one selected video clip in the selected segments with the respective selected magnification factor, and reproducing one of the selected music pieces, whereby
the selected segments with the at least one selected video clip are overlaid to each other on the screen according to a predefined scheme, the predefined scheme defining which one of the segments is displayed where at least two of the selected segments are overlapping on the screen, and defining the one music piece of the selected music pieces linked with the selected video clips which is to be reproduced.

16. A bundle of storage media, comprising:
at least one computer-readable storage medium according to claim 14, and
at least one audio storage medium, the audio storage medium being capable of being reproduced in an audio disk player, and comprising music pieces recorded thereon which correspond to the music pieces stored on the computer-readable storage medium.

17. A computer system for performing the method according to claim 1.
